(19) United States
(12) Patent Application Publication
(10) Pub. No.: US 2016/0354273 A1
(43) Pub. Date: Dec. 8, 2016

(54) SPINAL CORRECTION METHOD AND DEVICE

(71) Applicant: Kerry Johnson, St. Paul, MN (US)

(72) Inventor: Kerry Johnson, St. Paul, MN (US)

(21) Appl. No.: 15/236,991

(22) Filed: Aug. 15, 2016

Related U.S. Application Data
(62) Division of application No. 13/734,248, filed on Jan. 4, 2013.
(60) Provisional application No. 61/583,034, filed on Jan. 4, 2012.

(51) Int. Cl. A61H 1/02; A61H 23/02

(52) U.S. Cl. CPC A61H 1/0296; A61H 1/0218; A61H 23/02; A61H 2001/0233; A61H 2201/1607; A61H 2201/5007; A61H 2203/0456; A61H 2203/0493

(57) ABSTRACT

Spinal correction comparable to that achieved through mastery of the specific upper spinal correction procedure may be produced through the simple application of harmonic vibrations and light long axis traction to the spine. Accordingly, complex spine correction may be achieved through a relatively simple procedure, apt for automation. During the procedure the patient may be placed in a supine position and the patient's head supported. The patient's head may be elevated and/or positioned forward with respect to the rest of the body. Light long axis traction is then induced along the spine. During the induction of traction, vibrations are applied to the spine.

### CROSS-REFERENCE TO RELATED APPLICATION(S)

This application is a divisional of U.S. application Ser. No. 13/734,248 filed Jan. 4, 2013 for “SPINAL CORRECTION METHOD AND DEVICE” by Kerry Johnson and claims the benefit of U.S. Provisional Application No. 61/583,034 filed Jan. 4, 2012 for “SPINAL CORRECTION DEVICE” by Kerry Johnson.

### BACKGROUND OF THE INVENTION

Utilizing a very sophisticated system of specific upper spinal correction a small segment of chiropractors successfully achieve therapeutic spinal correction. Successfully practicing the specific upper spinal correction procedure entails delivering an extremely light, accurately placed force to the upper cervical spine to return the head, neck and spine to their normal orthogonal anatomical relationship. The location, direction and magnitude of the forces applied are generally determined by exacting X-ray analysis. Accordingly, precision X-ray alignment and accurate patient placement for X-rays are critical for successful specific upper spinal correction. After the required direction and amplitude of the force required is determined from X-ray analysis, the patient's head must be properly positioned and the force must be accurately applied with respect to both direction and amplitude. The complexity of specific upper spinal correction makes it difficult to learn and even more difficult to master.

### SUMMARY OF THE INVENTION

Spinal correction comparable to that achieved through mastery of the specific upper spinal correction procedure may be produced through the simple application of harmonic vibrations and light long axis traction to the spine. Accordingly, complex spine correction may be achieved through a relatively simple procedure, apt for automation. During the procedure the patient may be placed in a supine position and the patient's head supported. The patient's head may be elevated and/or positioned forward with respect to the rest of the body. Light long axis traction is then induced along the spine. During the induction of traction, vibrations are applied to the spine.

Directing the patient to lie down or otherwise placing the patient in a supine position helps the muscles along the spine to relax, lessening forces exerted on the spine by muscle guarding. During normal movement, joints, ligaments and/or muscles along the spine transmit signals to the central nervous system in response to being stretched. In response to stretch signals, the central nervous system directs muscles to contract to resist stretching of the spine. During daily activities these autocorrect signals assist in maintaining balance, posture and/or coordinated movement. However, stretch triggered autocorrect signals can also contribute to misalignment of the spine and can act against efforts to return the spine to proper alignment. Accordingly, in some instances it may be advantageous to lessen muscle guarding by having the patient relax in a supine position.

It may also be advantageous to avoid the induction of muscle guarding during correction. Avoiding muscle guarding can be accomplished by inducing light long axis traction along the spine. Light long axis traction applied to the spine in some instance may be below the threshold that would induce firing of neurological receptors in joints, ligaments and muscles in response to stretching. In some instances light long axis traction induced along the spine may be less than therapeutic traction. Accordingly, long axis traction of 27 pounds applied to the neck may be sufficient in some embodiments. In other instances, long axis traction of 12-13.5 pounds may be sufficient. Measuring the caudal force applied to the head may be done to monitor the amount of the traction.

Light long axis traction induced along the spine may, in some instances, provide a force urging the spine towards proper alignment. The ability of light long axis traction to urge the spine toward alignment may be enhanced by supporting the head equally on both lateral occipital regions of the skull. Additionally, during the induction of light long axis traction inferior movement of the skull may be inhibited.

Inducing light long axis traction may be accomplished by placing the patient in an inclined supine position so that traction is provided by the force of gravity. The use of gravity to supply light long axis traction may permit the spine to be consistently pulled in an exact direction. In some instances, the patient may find it more comfortable to have his head elevated above his feet.

Having the patient lay flat on his back on a tilted surface may be sufficient, in some instances, to induce light long axis traction along the spine. When so positioned, especially when inferior movement of the head is inhibited, the resulting light long axis traction may induce the spine to slide down the incline and into alignment, like a crooked rope being pulled straight. In some instances, movement of the spine down the incline may be assisted by the patient's tissue located between the spine and the inclined surface. The tissue may provide a surface of reduced friction along which the spine may move. Thus, in some instances, the spine may float upon underlying tissue and slide down the incline into alignment.

In addition to light long axis traction, vibrations applied to the spine may induce movement of the spine in the direction of induced light long axis traction. Accordingly, in some instances the combination of light long axis and vibrations applied to the spine may induce corrective force. If the patient is placed at an incline such that the force gravity supplies light long axis traction, then the spine may be pulled into perfect alignment. Vibrations may be applied for any length of time. With some patients, a five to eight minute application of light long axis traction and vibrations to the spine may be sufficient. In some instances, vibrations may be applied to multiple regions of the spine simultaneously. Accordingly, simultaneous movement and alignment of multiple regions of the spine may be induced. In some instances, the vibrations may be applied to the spine through surface supporting the patient. In other instances, vibrations may be applied to specific regions and/or points along the spine. For example, vibrations may applied the transverse process of C-1, the posterior aspect of C-1, the skull, the cervical region, the thoracic region, and the lumbar region. Sequential application of vibrations to various regions and/or locations of the spine may induce sequential movement and alignment. In some instance it may be desirable to induce harmonic vibrations along the entire spine and/or in one or more specific regions of the spine.

The vibrations applied to the spine may be a progressed from a low frequency to a high to frequency. Progressing the vibration across a frequency range may, in some embodiments, permit the induction of harmonic vibrations within each region of the spine. In some instances the vibrations applied to the spine may be between approximately 5 and approximately 85 Hertz.

### BRIEF DESCRIPTION OF THE DRAWINGS

A detailed description of the various embodiments of the invention is hereafter provided which makes specific reference to the following figures.

FIG. 1 depicts an embodiment of a spinal correction device.

FIG. 2 depicts an instance of applying light long action traction with the spinal correction device of FIG. 1.

FIG. 3 depicts an embodiment of a spinal correction device comprising spine supports and leg supports.

FIG. 4 depicts an embodiment of a clam clamp that may be associated a head support.

### DETAILED DESCRIPTION OF THE INVENTION

While the invention may be embodied in many different forms, there are described in detail herein specific embodiments of the invention. This description is an exemplification of the principles of the invention and is not intended to limit the invention to the particular embodiments illustrated.

For the purposes of this disclosure, like reference numerals in the figures shall refer to like features, unless otherwise indicated.

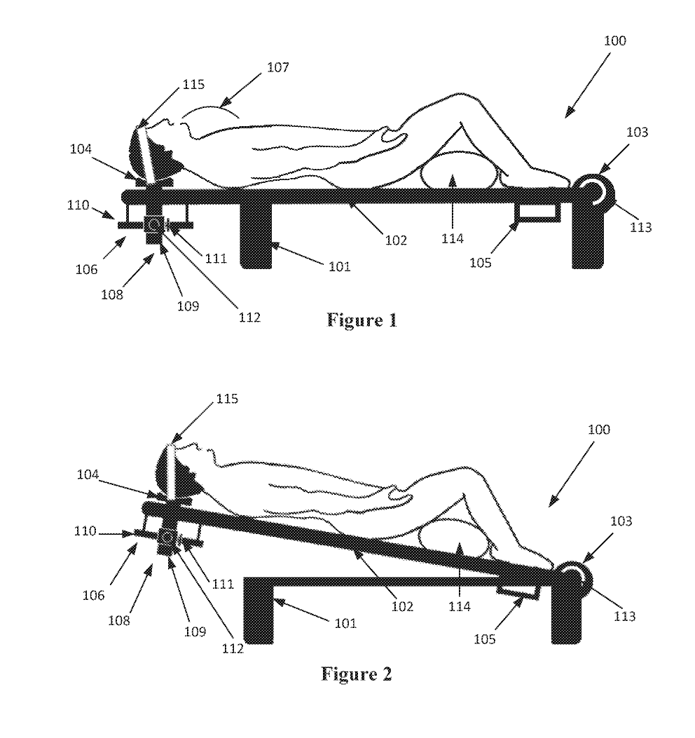

An embodiment of a light long axis traction spinal correction device 100 which may be used to practice the above procedure is shown in FIG. 1. Correction device 100 comprises base 101 supporting table top 102. Pivot joint 103 connects table top 102 to the base 101. Head support 104 on table top 102 supports a patient's head in an elevated position. Vibration element 105 in contact with table top 102 induces vibrations within table top 102 which are applied to the patient's spine.

As show in FIG. 1, a patient lies supine on table top 102. The patient's head is supported by head support 104. In some embodiments, head support 104 may be configured to support the patient's head equally on both lateral occipital regions of the skull behind the mastoid bone. In some embodiments, a head support 104 may prevent inferior movement of the head. Inferior movement of the head may be prevented by strap 115 associated with head support which secures the patient's head to head to support 104.

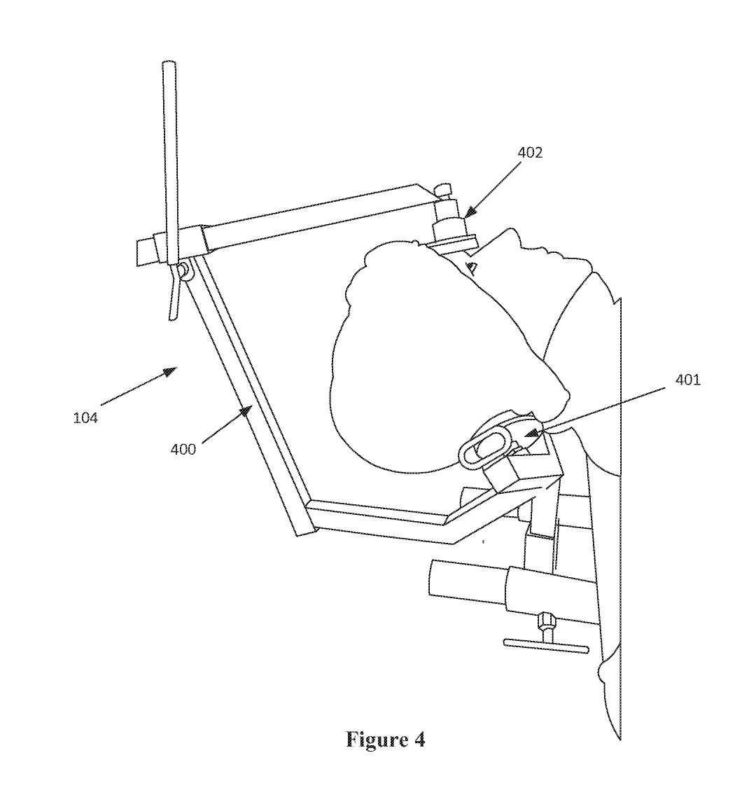

In combination or the alternative, head support 104 may include a clam clamp 400. FIG. 4 depicts an embodiment of clam clamp 400 having a bottom 401 matching the inward slope of the lower portions of the back of the head. The upper half 402 of the clam clamp 400 may be configured to extend over the patient's forehead and hook over the upper portion of the eye orbit, without pushing on the eye. Clam clamp 400 may be motorized or manually set. In some embodiments a force limited may be included to limit the force applied by clam clamp 400.

In some embodiments, a patient may be provided with a release the patient could actuate to release the head restraint associated with head support 104. In combination or the alternative, head support 104 may be configured to release the patient's head if traction applied to the neck exceeds a predetermined limit.

In some embodiments, head support 104 may comprise cephaled adjustment mechanism 106 permitting the patient's head to be positioned forward with respect to the body along arc 107. In combination or the alternative, head support 104 may comprise vertical adjustment mechanism 108 permitting raising and lowering of the patient's head above table top 102. A variety of adjustment mechanisms may be utilized in association with head support 102 to elevate and/or position the patient's head forward. The adjustment mechanisms associated with head support 104 of correction device 100 comprise vertical rail 109 and a horizontal rail 110 along which head support 104 may slide. Screws 111 and 112 secure head support 104 in position along rails 109 and 110, respectively.

After the patient lays supine on table top 102 with his head supported by head support 104, light long axis traction is induced along the spine by placing table top 102 at an incline, as shown in FIG. 2. The amount of traction applied may be measured and/or calculated. Protractor 113 measuring the angle of incline of table top 102 may permit the amount of tract induced along the spine to be calculated from the patient's weight. As shown in FIGS. 1 and 2, protractor 113 may be associated with pivot joint 103. In combination or the alternative, protractor 113 may be associated with table top 102 and/or otherwise positioned to measure the incline of table top 102. In some embodiments, the incline of table top 102 may be limited to 12 degrees.

In combination or the alternative to calculating traction from the incline of table top 102, a traction force meter associated with head support 104 may permit the amount traction applied along the spine to be measured.

While table top 102 is inclined, vibrations are generated within table top 102 by vibration element 105. The vibrations generated within table top 102 are applied to the patient's spine. Accordingly, during the induction of light long axis traction vibrations generated by vibration element 105 are transferred through table top 102 into the patient's spine. When transferring vibrations to the patient's spine, vibrating table top 102 moves up and down with respect to the patient's spine. As vibrating table top 102 moves upward it exerts an increasing force against the patient Likewise, as vibrating table top 102 moves down the force exerted against the patient decreases. The maximum force exerted against the patient by the upward movement of table top 102 is referred to as the force amplitude of the vibrations. In some embodiments, the force amplitude of the vibrations applied to the spine may be between approximately 0.2 and approximately 2.0 pounds.

The combination of the induced light long axis traction and vibrations applied to the spine through table top 102 induces the spine to slide down the incline of table top 102 and into alignment, like a crooked rope being pulled straight. In some embodiments, movement of the spine into alignment may be facilitated by leg support 114 on table top 102. Positioning leg support 114 beneath the patient's knees may remove resistance to movement from the patient's leg. Leg support 114 may be a cushion, as shown in FIGS. 1 and 2.

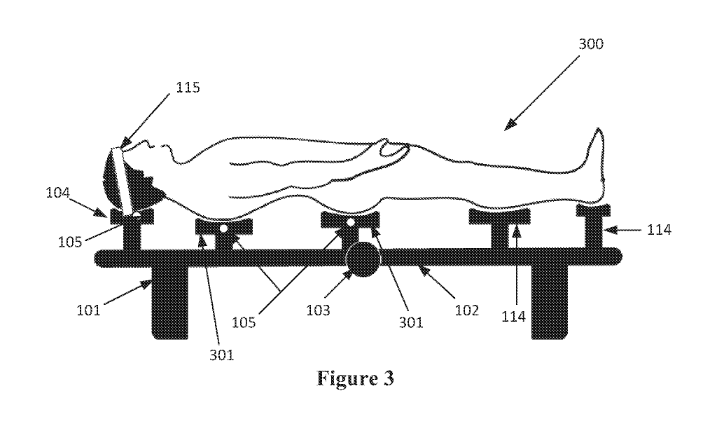

FIG. 3 depicts an alternative embodiment of a light long axis traction spinal correction device. Table top 102 of light long axis traction spinal correction device 300 depicted in FIG. 3 is balanced about pivot joint 103. Balanced about pivot joint 103, table top 102 may be inclined with reduced effort. The incline of table top 102 of device 300 may be measured by a protractor associated with table top 102.

Device 300 comprises spine supports 301 on table top 102. Adjusting the vertical placement of spine supports 301 allows support of the patient in a supine position with the spine curved as in the standing position. The vertical placement of spine supports 301 may be adjusted using vertical adjustment mechanisms associated with spines supports 301. Movement of the spine during correction may be enhanced in some embodiments with rollers and/or slides incorporated into spine supports 301.

In addition to spine supports 301, device 300 supports the patient in a supine position with leg supports 114. Adjusting the vertical placement of leg supports 114 may permit the patient to be supported in a supine position with their legs positioned with respect to the spine as if in a standing position. The vertical placement of leg supports 114 may be adjusted using vertical adjustment mechanism associated with leg supports 114. Movement of the legs during correction may be enhanced in some embodiment with rollers and/or slides incorporated into leg supports 114.

In addition to supporting the patient in a supine position, head support 104 and/or spine supports 301 may transfer vibrations to the spine. The vibrations applied to the spine by head support 104 and/or leg supports 301 may be generated by vibration element 105 in contact with table top 102. Accordingly, in some embodiments vibrations generated by vibration element 105 may be transferred through table top 102, up supports 104 and/or 201 and into the patient's spine.

In combination or the alternative, head support 104 and/or at least one spine supports 301 may be associated directly with individual vibration elements. Vibrations generated by vibrations elements could then be transferred directly from supports 104 and/or 301 to the patient's spine. In some embodiments, a vibration element may be positioned at the portion of head support 104 and/or at least one spine supports 301 contacting the patient. In such embodiments, vibrations generated would be applied directly to the patient's spine.

Device 300 depicted in FIG. 3 incorporates vibration elements 105 atop of head support 104 and spin supports 301. In some embodiments force meters may be associated with head support 104 and spine supports 301 for measuring the force amplitude of the vibrations applied to the spine at head support 104 and spine supports 301. In combination or the alternative, fore meters measuring the force amplitude of vibrations applied to the spine may associated with base 101 and/or table top 102. In some embodiments, a force meter measuring the force amplitude of the vibrations may be a transducer.

In some embodiments a computer with software may interface with the spinal correction device. The software may accept as input patient data, reference previous treatment data and determine recommended treatment parameters. The software may then, in some embodiments, display the recommended treatment parameters to the clinician who sets the correction device accordingly. In combination or the alternative, the software may set the correction device to all or some of the recommended parameters by controlling the vibration element and/or incline of the table top.

The patient data inputted into the software may include age, weight, body type, gender and/or various physiological measurements. The accepted physiological measurements may include height, postural measurements such as standing weight difference, pelvic rotation, fixed point deviation, leg length inequality, uneven shoulders and/or head tilt, and/or x-ray measurements such as atlas lateral displacement, lower cervical angle, C2 rotation and/or atlas rotation.

The recommended treatment parameters may include the incline of the table top, force amplitude of the applied vibrations, frequency of the applied vibrations and/or duration of treatment.

Previous treatment data may include patient data, treatment parameters and/or outcome data such post treatment physiological measurements.

In determining recommended treatment parameters, the software may compare inputted patient data to previous treatment data. In some embodiments, the comparison entails searching and selective previous treatment data matching one or more elements of patient data, such as weight. The software may then output and/or set the correction device to all or some of the treatment parameters associated with the returned previous treatment data. In some situations it is possible the software may identify multiple previous treatment data matching the patient data. In such situations, the software may select the previous treatment data best matching the patient data. In combination or the alternative, the recommend treatment parameters may the mean, median and/or other mathematical representation of the previous treatment data associated with the returned previous treatment data.

The above disclosure is intended to be illustrative and not exhaustive. This description will suggest many variations and alternatives to one of ordinary skill in this field of art. All these alternatives and variations are intended to be included within the scope of the claims where the term “comprising” means “including, but not limited to.” Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

All US patents and applications and all other published documents mentioned anywhere in this application are incorporated herein by reference in their entirety.

A brief abstract of the technical disclosure in the specification is also provided for the purposes of complying with 37 C.F.R. 1.72. The abstract is not intended to be used for interpreting the scope of the claims.

This completes the description of the preferred and alternate embodiments of the invention. Those skilled in the art may recognize other equivalents to the specific embodiment described herein which equivalents are intended to be encompassed by the claims attached hereto.

I claim:

1. A method of correcting a spine of a patient, the method comprising:
a. placing the patient in a supine position;
b. supporting a head of the patient;
c. inducing light long axis traction along the spine; and
d. applying vibrations to the spine during the induction of light long axis traction.

2. The method according to claim 1 further comprising supporting the head equally on both lateral occipital regions of a skull of the patient's head.

3. The method according to claim 1 further comprising inhibiting inferior movement of the skull during the induction of light long axis traction.

4. The method according to claim 1 further comprising placing the patient in an inclined position, wherein the head is elevated above feet of the patient.

5. The method according to claim 1 further comprising measuring caudal force applied to the head.

6. The method according to claim 1 further comprising inducing harmonic vibrations within at least a region of the spine.

7. The method according to claim 1 wherein the vibrations are applied at locations selected from a group consisting of the transverse process of C-1, a posterior aspect of C-1, a skull, a cervical region, a thoracic region, and a lumbar region.

8. The method of claim 1, wherein force amplitude of the vibrations applied to at least a region of the spine is between approximately 0.2 and 2.0 pounds.

9. The method of claim 1, wherein the frequency of the vibrations applied to at least a region of the spine is between approximately 5 and 85 Hertz.

10. The method according to claim 1 further comprising increasing the frequency of the vibrations applied to at least a region of the spine.

11. The method according to claim 1 wherein the vibrations are applied to at least a region of the spine for a period of time between approximately five and eight minutes.

12. A method of correcting the spine of a patient, the method comprising:
a. placing the patient in a supine position;
b. supporting a head of the patient;
c. inducing light long axis traction along the spine without inducing muscle guarding by placing the patient in an inclined position of less than 12 degrees of incline, wherein the head is elevated above feet of the patient; and
d. applying vibrations to the spine during the inducing of light long axis traction at a frequency and force amplitude that induces harmonic vibrations within at least a region of the spine.

13. The method according to claim 12 further comprising supporting the head equally on both lateral occipital regions of a skull of the patient's head.

14. The method according to claim 1 further comprising inhibiting inferior movement of the skull during the induction of light long axis traction.

15. The method according to claim 12 wherein the long axis traction force applied to a neck of the patient is27 pounds or less.

16. The method according to claim 12 wherein the vibrations are applied at locations selected from the group consisting of a transverse process of C-1, a posterior aspect of C-1, a skull, a cervical region, a thoracic region, and a lumbar region.

17. The method of claim 12, wherein the force amplitude of the vibrations applied to the spine is between approximately 0.2 and 2.0 pounds, and wherein the frequency of the vibrations applied to the spine is between approximately 5 and 85 Hertz.

18. The method according to claim 12 further comprising increasing the frequency of the vibrations applied to the spine during a time period in which the vibrations are applied.

19. The method according to claim 12 wherein the vibrations are applied to the spine for a period of time between approximately five and eight minutes.

20. A method of correcting a spine of a patient, the method comprising:
a. placing the patient in a supine position;
b. supporting a head of the patient;
c. inducing light long axis traction along the spine by placing the patient in an inclined position of less than 12 degrees of incline, wherein the head is elevated above feet of the patient; and
d. applying vibrations to the spine for a period of time between approximately five and eight minutes during the induction of light long axis traction, wherein force amplitude of the vibrations applied to the spine is between approximately 0.2 and 2.0 pounds and frequency of the vibrations applied to the spine is between approximately 5 and 85 Hertz, wherein the vibrations are applied at locations selected from the group consisting of a transverse process of C-1, a posterior aspect of C-1, a skull, a cervical region, a thoracic region, and a lumbar region.
